(19) United States
(12) Patent Application Publication
(10) Pub. No.: US 2015/0296711 A1
(43) Pub. Date: Oct. 22, 2015

(54) MOWER DECK LEVELING SYSTEM

(71) Applicant: DEERE & COMPANY, MOLINE, IL (US)

(72) Inventors: Robert D. Haun, FUQUAY VARINA, NC (US); HARLIN J. TREFZ, JACKSON, TN (US)

(73) Assignee: DEERE & COMPANY, MOLINE, IL (US)

(21) Appl. No.: 14/255,573

(22) Filed: Apr. 17, 2014

(51) Int. Cl. A01D 69/02; A01D 34/00

(52) U.S. Cl. CPC A01D 69/02; A01D 34/006

(57) ABSTRACT

A mower deck leveling system includes first and second electric actuators that change the spacing between a first side of the mower deck and a lawn and garden tractor frame, and the spacing between a front of the mower deck and the lawn and garden tractor frame. First and second sight levels on the mower deck indicate if the first side of the mower deck is level with a second side of the mower deck, and if the front of the mower deck is level with the back of the mower deck. At least one electric switch in the operator station is connected to the electric actuators.

### FIELD OF THE INVENTION

This invention relates to mower decks suspended from lawn and garden tractors and other grass mowing machines, and more specifically to a mower deck leveling system to properly level and align a mower deck and a procedure for its use.

### BACKGROUND OF THE INVENTION

A mower deck may be suspended from a lawn and garden tractor or other vehicle, or “floated” on wheels attached to the mower deck. The mower deck may cover one or more rotary cutting blades. When a mower deck is suspended from a vehicle frame, the mower deck and blades should be in proper alignment relative to the mowing vehicle at all cutting heights. For example, the mower deck should be properly aligned so that each rotary cutting blade is level side-to-side, and has a slight forward angle or “rake.” Proper alignment of the mower deck helps achieve better cut quality, prevents grass frazzling, provides better grass dispersal, better bagging results, and reduces the power required to run the engine. Additionally, the mower deck should be calibrated so that the blades are at the cutting height specified by the mower deck height control knob or lever.

To determine if a mower deck is level and properly aligned at a designated cutting height, several measurements may be taken. Typically, measurements can be taken from a hard, level floor or ground surface under the vehicle up to the tip of a rotary cutting blade. To check if the mower deck is level side-to-side, the blades are manually rotated to a position parallel to the vehicle axle and measurements are taken from the ground up to the left and right outside blade tips. To check if the mower desk is properly aligned front-to-rear, the blades are rotated to point straight forward and backward, and measurements are taken from the ground up to the front and rear blade tips. U.S. Pat. No. 8,544,249 describes a more convenient and simple mower deck leveling gauge and procedure, with a one-piece gauge dimensioned to fit under each deck level measuring point at a specified cutting height. A low cost mower deck leveling system is needed that allows an operator to determine if the deck is level while remaining seated on a lawn tractor.

After the measurements, one or more adjustments may be made on the linkages between the mower deck and vehicle frame. For example, to level the mower deck side-to-side, a nut or other connector on the left-hand lift link may be turned to raise or lower the left side of the mower deck. Similarly, to properly align the mower deck front-to-rear, yokes or other connectors between the front of the mower deck and vehicle frame may be rotated in either direction to lift or lower the front of the mower deck. Additionally, linkages may be adjusted so that the height of the cutting blades corresponds to the cutting height designated on the mower deck height control knob or lever. The linkages may include threaded hangers, cams, or slotted mounting brackets attaching the hangers, cams, or slotted mounting brackets attaching the deck to the vehicle frame. The measuring process may need to be repeated again to calibrate the deck height control knob or lever; i.e., to insure that the final cutting height is the same as the height specified on the deck height control.

In the past, accessing these linkages was done by reaching around the mounting and drive components between the mower deck and fender deck. However, it is difficult for most operators to access the proper adjustment linkage and make adjustments using a wrench or similar tool. As a result, deck leveling is a slow and uncomfortable task that is often neglected or performed inadequately, resulting in uneven cut quality. U.S. Pat. No. 7,861,502 describes a top adjusting linkage for leveling a mower deck that includes an access opening through which the operator can insert a tool to engage and turn the upper end of a lift rod. A mower deck leveling system is needed that allows adjustments to be made without tools.

### SUMMARY OF THE INVENTION

A mower deck leveling system includes a first and a second sight level mounted on an upper surface of a mower deck that extends out from under an operator station of a lawn tractor. At least one electrical switch may be actuated from the operator station and connected to first and second electrical actuators that raise and lower a side of the mower deck and a front of the mower deck. The first electric actuator changes the spacing of a connection between a lawn and garden tractor frame and a side of a mower deck relative to the other side of the mower deck. The second electric actuator changes the spacing of a connection between the front of the lawn and garden tractor frame and the mower deck relative to the back of the mower deck. The mower deck leveling system is low cost and allows an operator to determine if the deck is level while remaining seated on a lawn tractor and without tools.

### BRIEF DESCRIPTION OF THE DRAWINGS

FIG. 1 is a side view of a lawn and garden tractor, partially in section, with a mower deck leveling system according to a first embodiment of the invention.

FIG. 2 is a top view of a mower deck leveling system on a lawn and garden tractor according to a first embodiment of the invention.

FIG. 3 is a perspective view of a first electric actuator of a mower deck leveling system according to a first embodiment of the invention.

FIG. 4 is a perspective view of a second electric actuator of a mower deck leveling system according to a first embodiment of the invention.

### DESCRIPTION OF THE PREFERRED EMBODIMENT

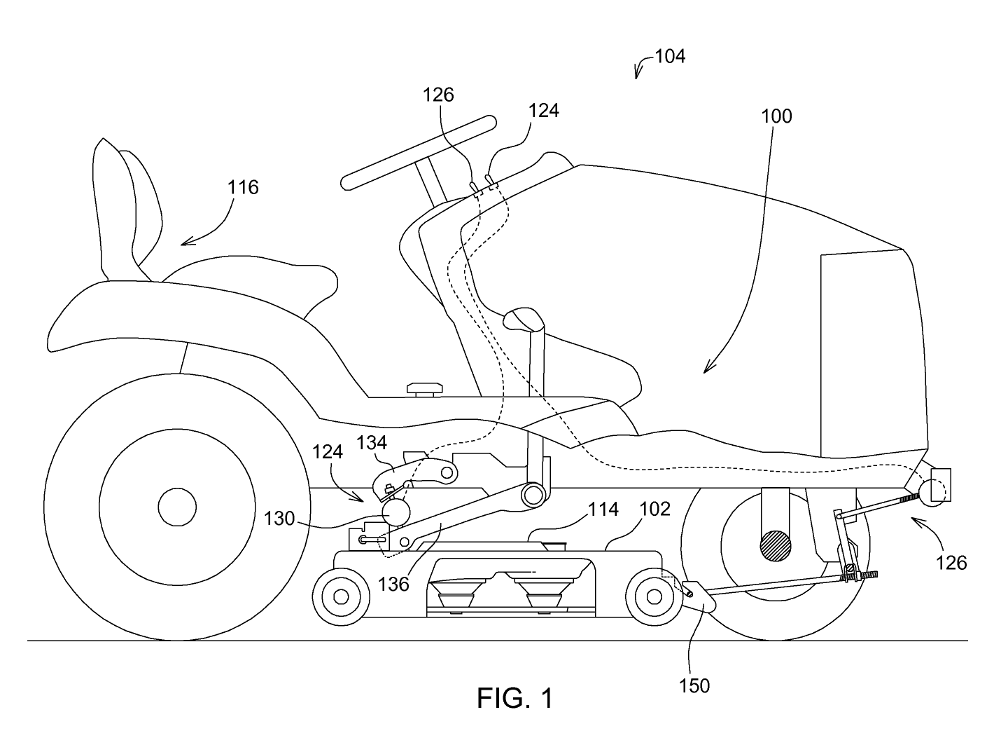

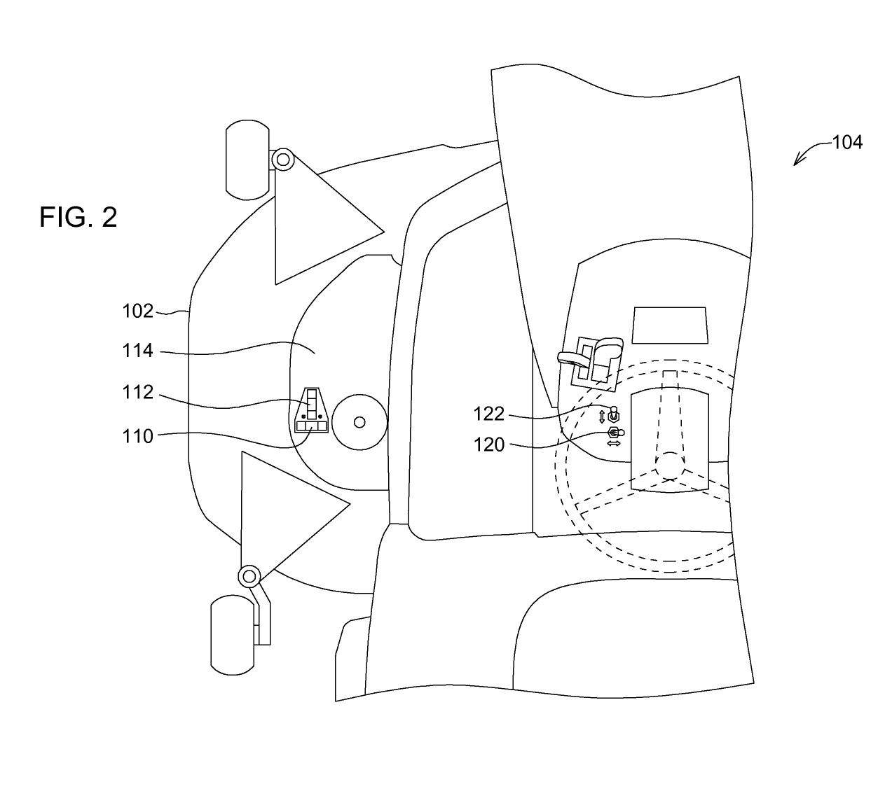

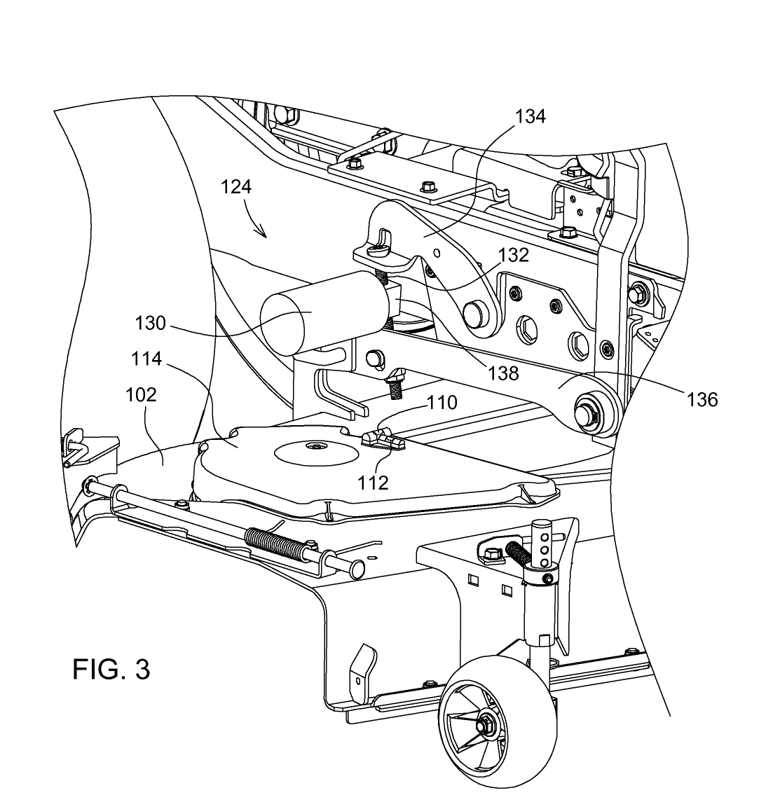

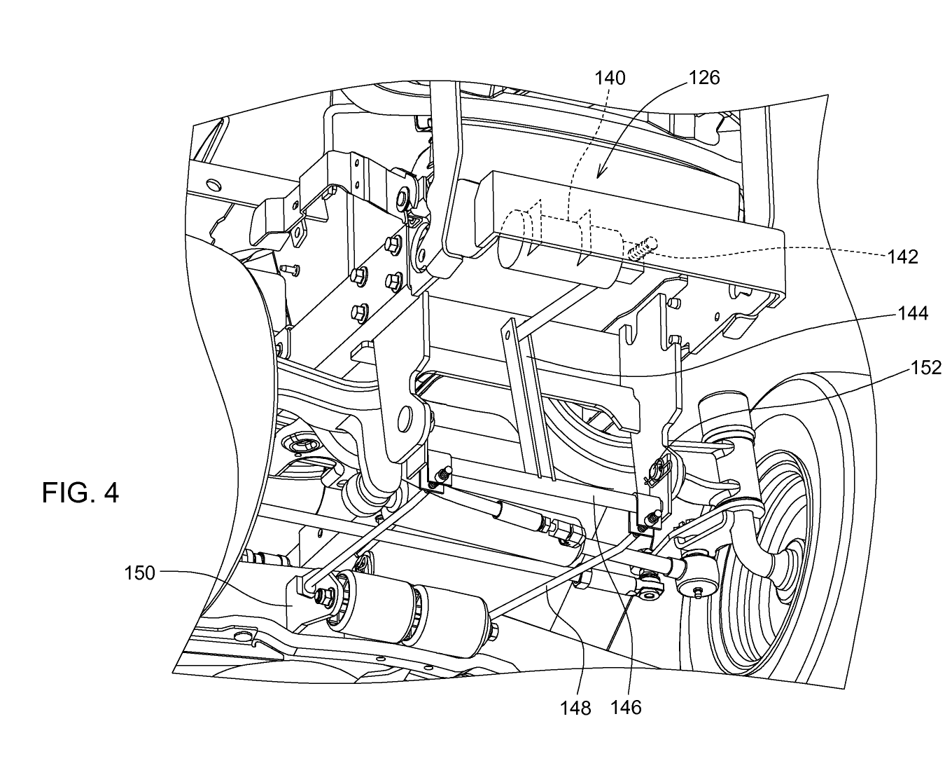

FIGS. 1-4 show one embodiment of mower deck leveling system 100. The mower deck leveling system may be used on mower deck 102 mounted to lawn and garden tractor 104 between the lawn tractor's front and rear wheels. The mower deck may cover a plurality of rotary mower blades, each blade mounted to the lower end of a spindle. Pulleys on the upper ends of the spindles may be rotated by one or more endless belts driven by an internal combustion engine or other power source on the lawn tractor.

In one embodiment, mower deck leveling system 100 may include first and second sight levels 110, 112 mounted and affixed to an upper or top surface of mower deck 102 that extends outwardly from under the operator station of a lawn and garden tractor and are visible from operator seat 116. For example, first sight level 110 may have a side-to-side orientation, and second sight level 112 may have a front-to-back or fore-and-aft orientation. Both sight levels may be mounted on the upper surface of belt guard 114 or another flat portion of the mower deck where the sight levels are visible to an operator on seat 116. While operating the lawn tractor, an operator can observe the sight levels to determine if the mower deck is level while the lawn tractor is stopped or operating.

In one embodiment, mower deck leveling system 100 may include first and second electrical switches 120, 122 mounted in the lawn tractor's operator station and accessible from the operator seat. For example, first electrical switch 120 may be used for side-to-side leveling of the mower deck, and second electrical switch 122 may be used for fore-and-aft or front-to back leveling. First and second electrical switches 120, 122 may be connected to first and second electric actuators 124, 126. Each electrical switch may be a toggle switch, and each electric actuator may include an electric motor that turns a threaded output shaft. Alternatively, the mower deck leveling system may include a single electrical switch connected to one or more electric actuators.

In one embodiment, first electric actuator 124 may be used for side-to-side leveling of the mower deck. For side-to-side leveling, first electric actuator 124 may be provided on only one side of the mower deck which may be adjusted relative to the other side of the mower deck. First electric actuator 124 changes the spacing of a connection between the lawn and garden tractor frame and one side of the mower deck. For example, a deck lift arm or rockshaft 134 and draft arm or mower link 136 may be connected to the frame and may support one side of them mower deck. For example, the first electric actuator may include first electric motor 130 that rotates first threaded output shaft 132 that connects between lift arm or rockshaft 134, and draft arm or mower link 136. First electric motor 130 may have an axis that is mounted transversely to the first threaded output shaft and may have a worm gear arrangement that engages and turns the first threaded output shaft. One end of the first threaded output shaft may engage internally threaded lift link 138 attached to right draft arm or mower link 136. An operator may move first electrical switch 120 to the left or right to rotate first threaded output shaft 132 which raises or lowers one side of the mower deck until the operator observes that first side-to-side sight level 110 shows that side of the mower deck is at the same level as the other side of the mower deck.

In one embodiment, second electric actuator 126 may be used for front-to-back or fore-and-aft leveling of the mower deck. For front-to-back leveling, second electric actuator 126 may be provided on only the front of the mower deck which may be adjusted relative to the back of the mower deck. Second electric actuator 126 may change the spacing of a connection from the frame to the front of the mower deck. For example, front rock shaft 146 and front link 148 may be connected to the frame and may support the front of the mower deck. For example, the second electric actuator may include second electric motor 140 that rotates second threaded output shaft 142 extending between a fixed location at or near the front of the lawn tractor frame or bumper, and front lift arm 144 attached to front rock shaft 146. Second electric motor 140 may have an axis that is mounted transversely to the second threaded output shaft and may have a worm gear arrangement that engages and turns the second threaded output shaft. One end of the second threaded output shaft may engage lift arm 144 which may be welded to and extend transversely from an intermediate part of front rock shaft 146 that is offset from rotational axis 152 on the forward end of the frame. The front of the mower deck may have hooks 150 that hang from and/or may be connected to front link 148 which also may be pivotably connected to the offset intermediate part of the front rock shaft. Lift arm 144 may be used to pivot the offset part of the rockshaft in one direction to move the front link up and forward to raise the front of the mower deck, or in the other direction to move the front link down and back to lower the front of the mower deck. An operator may move second electrical switch 122 to the front or back to rotate second threaded output shaft 142 which raises or lowers the front of the mower deck until the operator observes that second fore-and-aft sight level 112 shows the front of the mower deck is at the same level as the back of the mower deck which is connected to the mower by the rockshaft and lift arms. The first and second electrical switches and actuators may be connected to a battery power source on the lawn and garden tractor to provide a circuit.

Having described the preferred embodiment, it will become apparent that various modifications can be made without departing from the scope of the invention as defined in the accompanying claims.

1. A mower deck leveling system, comprising:
a first sight level and a second sight level mounted on an upper surface of a mower deck that extends out from under an operator station of a lawn tractor; and
at least one electrical switch actuatable from the operator station and connected to a first electrical actuator and a second electrical actuator that raise and lower a side of the mower deck and a front of the mower deck.

2. The mower deck leveling system of claim 1 wherein each of the first and the second electrical actuators includes an electric motor rotating a threaded rod.

3. The mower deck leveling system of claim 2 wherein each electric motor has an axis that is transverse to the threaded rod.

4. The mower deck leveling system of claim 1 wherein the first and the second sight levels are mounted on a belt guard on the mower deck.

5. A mower deck leveling system, comprising:
a first electric actuator changing the spacing of a connection between a lawn and garden tractor frame and a first side of a mower deck relative to a second side of the mower deck;
a second electric actuator changing the spacing of a connection between a front of the lawn and garden tractor frame and the mower deck relative to a back of the mower deck; and
a first electrical switch and a second electrical switch in an operator station actuating the first and the second electric actuators.

6. The mower deck leveling system of claim 5 further comprising a first sight level and a second sight level on a top surface of the mower deck.

7. The mower deck leveling system of claim 5 wherein the first electric actuator includes a first electric motor that rotates a first threaded rod.

8. The mower deck leveling system of claim 5 wherein the second electric actuator includes a second electric motor that rotates a second threaded rod.

9. The mower deck leveling system of claim 5 wherein the connection between the front of the lawn and garden tractor frame and the mower deck includes a front rockshaft having an intermediate part offset from a rotational axis, a front lift arm extending transversely from the intermediate part and engaged by a threaded rod, and a front link extending rearwardly from the intermediate part to the mower deck.

10. The mower deck leveling system of claim 5 wherein the connection between the lawn and garden tractor frame and the first side of the mower deck includes a deck lift arm connected to a mower link by a threaded rod.

11. A mower deck leveling system, comprising:
a first electric actuator and a second electric actuator that change the spacing between a first side of the mower deck and a lawn and garden tractor frame, and the spacing between a front of the mower deck and the lawn and garden tractor frame; and
a first sight level and a second sight level on the mower deck that indicate if the first side of the mower deck is level with a second side of the mower deck, and if the front of the mower deck is level with a back of the mower deck.

12. The mower deck leveling system of claim 11 wherein the first and the second electric actuators include electric motors that rotate threaded rods.

13. The mower deck leveling system of claim 11 further comprising at least one electric switch in an operator station of the lawn and garden tractor connected to the first and the second electric actuators.
